(19) United States
(12) Patent Application Publication
(10) Pub. No.: US 2013/0009427 A1
(43) Pub. Date: Jan. 10, 2013

(54) FOLDING TABLE AND CHAIR SET WITH PARTIALLY OPEN CARRYING CASE

(75) Inventors: Mitch Johnson, South Weber, UT (US); David C. Winter, Layton, UT (US); Wendell Peery, Kaysville, UT (US); Joel Bennett, Clinton, UT (US); Brandon Smith, South Ogden, UT (US)

(73) Assignee: LIFETIME PRODUCTS, INC., Clearfield, UT (US)

(21) Appl. No.: 13/346,580

(22) Filed: Jan. 9, 2012

Related U.S. Application Data
(60) Provisional application No. 61/432,193, filed on Jan. 12, 2011.

(51) Int. Cl. A47B 3/14; B29C 49/42

(52) U.S. Cl. 297/135; 264/534

(57) ABSTRACT

A table and chair set may include a table, a plurality of chairs and a storage case. The table may include a folding table top that has a footprint in the folded position. The chairs may be folding chairs that have a footprint generally equal to or slightly smaller than the footprint of the table in the folded position. The case may include an interior cavity that is sized and configured to receive at least a portion of the table and the chair in the folded positions.

### CROSS-REFERENCE TO RELATED APPLICATIONS

The present application claims priority to and the benefit of U.S. Provisional Patent Application Ser. No. 61/432,193, entitled FOLDING TABLE AND CHAR SET WITH PARTIALLY OPEN CARRYING CASE, which was filed on Jan. 12, 2011, and is hereby incorporated by reference in its entirety.

### BACKGROUND OF THE INVENTION

1. Field of the Invention

The present invention is generally directed towards furniture, such as tables and chairs. The tables and chairs may be part of a set and a carrying case may be used to transport and/or store the tables and chairs.

2. Description of Related Art

Many types of tables are well known and used for a variety of purposes. For example, conventional tables may include a table top and legs that are attached to the table top. Known tables may also include folding legs that are pivotally attached to the table top. The folding legs may be movable between a use position in which the legs extend outwardly from the table top and a storage position in which the legs are folded against an underneath surface of the table top. Tables with large, rectangular table tops and folding legs are often referred to as “banquet tables” and these tables are often used in places such as assembly halls, banquet halls, convention centers, hotels, schools, churches, and other locations where large groups of people meet. Tables with smaller, square table tops and folding legs are often referred to as “card tables.” Because banquet and card tables include folding legs, the tables are relatively portable and can be moved or stored when no longer needed. The folding legs allow the tables to be stored in smaller areas than tables without folding legs.

The ability to move the folding legs into a collapsed position allows the table to be more conveniently stored. Even when the legs are collapsed, however, the table top of many conventional tables still retains its original size and shape. For instance, conventional card tables often have sides measuring about three feet in length. As a result, the storage of card tables even with the legs in the collapsed position still requires a relatively large area.

When a table is used, it is frequently desired to allow people to sit at the table to allow one or more persons to eat, work, or undertake other activities. Therefore, chairs are frequently used in connection with tables. Conventional chairs typically include four legs, a chair seat and a chair back. When the chairs are not in use and desired to be stored, some known chairs may be stacked one on top of the other. The vertically stacked chairs have the same or slightly larger footprint that a single chair. Thus, for example, if the chairs have a length and width between about eighteen inches to about twenty four inches, then the stacked chairs will still require about the same amount of floor space as one of the chairs. Moreover, as more and more chairs are stacked, the stack can become prone to leaning or tipping. In order to prevent the stacked chairs from falling over, the number of chairs that may be stacked may be limited and multiple stacks of chairs may be required, which may necessitate the use of additional space.

To alleviate some of the challenges associated with stackable chairs, conventional folding chairs may be used. Known folding chairs are typically lightweight, portable chairs that fold relatively flat and can be stored in a stack or row. Folding chairs are generally used for seating in areas where permanent seating is not possible or practical. This may include outdoor and indoor events such as funerals, college graduations, religious services, sporting events and various types of competitions. Folding chairs may also be used in the home when additional seating is required such as for parties, card games, and other social events. Many folding chairs include a pivot point proximate a rear portion of the seat and the seat is generally aligned with the backrest and back supports when the chair is in the folded position.

When a folding chair is disposed in the folded position, it has a depth that is much less than in the unfolded position. For instance, in the use position, a conventional folding chair may be about eighteen inches wide, about eighteen inches deep, and about thirty-five inches high. In the collapsed or folded position, the depth of the chair may be much smaller, such as between four or five inches, while generally maintaining the same width and height of the chair. Consequently, a single folding chair may be stored in an area that is much smaller than a comparable non-folding chair. It is known that multiple folding chairs may be aligned or stacked in the folded position. Disadvantageously, the stacked or aligned chairs are often not very stable and have a tendency to fall over. In addition, the chairs may require a large amount of space even in the folded position.

Furthermore, transporting conventional tables and chairs can be problematic. For example, banquet tables are often difficult to move because of their large size and weight. This may make it challenging to move by a single person and two or more people may be required. Banquet tables may also be precluded from being transported in the trunk or back seat of a car or automobile because of its large size. Therefore, a truck, trailer or other large sized vehicle may be necessary to move the tables, especially if multiple tables are being transported. Similarly, while a single chair may be movable by a single person, often times multiple chairs are required and it is difficult for a single person to carry or move more than one chair in a single trip. In addition, when a single person attempts to carry two or more chairs, the chairs may be difficult to grip and may be easily dropped, especially if going up or down stairs, around corners, or traveling long distances. Consequently, multiple people and/or multiple trips are often required to move convention tables and chairs.

### BRIEF SUMMARY OF THE INVENTION

A need therefore exists for tables and chairs that eliminate the above-described disadvantages and problems.

One aspect is a table and chair set that may be sized and configured to be used together. Advantageously, the tables and chairs may be used in combination or as part of a group or collection. For instance, the table and chair set may include a table and four chairs. In addition, an open-ended carrying case may be used in connection with the table and chairs. Significantly, the table, chairs and carrying case may provide a useful, efficient and convenient way to transport and/or store the table and chairs.

Another aspect is a table that may include a table top and one or more legs or support structures. The legs are preferably movable between an extended or use position and a folded or collapsed position relative to the table top. The table may be a fold-in-half table in which the table top may be moved between folded and unfolded positions. For example, in the unfolded position, the table top may include two sections that are generally disposed in the same plane with an upper surface of the first section generally aligned with an upper surface of the second section. In the folded position, the first and second sections of the table top may be positioned generally adjacent to each other such that one section is disposed on top of the other section.

Still another aspect is a chair that may include legs, seat and backrest. The chair is preferably a folding chair that is movable between a use or unfolded position and a collapsed or folded position. When the chair is in the folded position, the legs may be generally aligned in a parallel configuration and the seat may be generally aligned with the backrest.

Yet another aspect is a container that may be sized and configured to receive at least a portion of one or more folding tables and chairs. In particular, the container, which may form at least a portion of a portable carrying and/or storage case, may be sized and configured to receive one or more tables and chairs in the folded position. Advantageously, the container may form part of the table and chair set. For example, the set may include a fold-in-half table and four folding chairs, and the container may be sized and configured to receive the table and chairs in the folded position. The container may include an outer shell and an interior portion that is sized to receive the table and chairs in the folded position. The container may also include an open end in which a portion of the table and chairs may be exposed. Significantly, the container may not only assist in transporting and/or storing the table and chairs, the container may also help protect the table and chairs from damage.

A further aspect is a table and chair set that may include a folding table that is selectively movable between folded and unfolded configurations. The table and chair set may also include one or more folding chairs that are selectively movable between folded and unfolded configurations. The table and chair set may be sized and configured to be disposed in a container or case, preferably when the table and chairs are in the folded positions.

A still further aspect is a table and chair set that may include at least one folding table and at least one folding chair. If desired, the table and chair set may include a folding table, four folding chairs and a case or container with an interior portion or cavity that is sized and configured to receive the table and chairs. Advantageously, the cavity may correspond to the size of the table and chairs in a folded and stacked configuration. In particular, the table and chairs may be disposed in the folded positions and the folded table and chairs may be stacked in an aligned configuration. Desirably, an outer perimeter of the folding table and chairs may also be aligned in the stacked configuration. The stacked, folded table and chairs may be disposed within the cavity of the case such that the table and chairs are generally aligned in parallel planes, adjacent tables and chairs contact or abut, and the table and chairs are sandwiched together within the case. Advantageously, this may allow the table and chairs to be efficiently and orderly transported and/or stored.

Yet another further aspect is a method for storing a table and chair set within a case. For instance, the case may include an opening or an open end, and a receiving portion. A plurality of chairs, preferably in a folded configuration, may be inserted into the opening and at least partially or substantially placed within the receiving portion. Additionally, a table, preferably also in the folded configuration, may be inserted into the opening and at least partially or substantially placed within the receiving portion. This may allow the table and chairs to be quickly and efficiently stored within the case.

Another aspect is a table and chair set that may include a storage case. For example, the set may include a table with a square table top that folds in half with each portion of the table top having generally the same length and width. The set may also include four substantially identical folding chairs. When the chairs and table are in the folded position, the chairs and table preferably have generally the same width and length, or footprint. In particular, the folding chairs can have a footprint in the folded configuration that is generally equal to or less than the size of the footprint of the table in the folded configuration. Significantly, if the table and chairs have generally the same footprint in the folded positions, that may facilitate stacking and/or alignment of the table and chairs. This may also allow the outer perimeter of the chairs and tables to be generally aligned when the folded table and chairs are stacked. Advantageously, if the folded table and chairs have generally the same footprint, the aligned table and chairs may be easily and efficiently disposed within the case. In addition, because the case may have an interior cavity that is only slightly larger than the folded table and chairs, the table and chairs may be snugly disposed within the case, which may minimize the required storage area. In addition, the case may include hard or rigid sides, which may help position and/or align the tables and/or chairs within the case. Further, the case may facilitate shipping and/or storage of the table and chairs, and may help protect the table and chairs from damage during shipping and/or storage, especially if the case has hard sides.

Still another aspect is case or container for a table and chair set that may be constructed from blow-molded plastic. For example, the entire outer shell or body of the container may be constructed as part of a unitary, one-piece structure during the blow-molding process. In this embodiment, the case may include an outer wall constructed from a single layer of plastic and the interior portion, which is sized and configured to receive the folded table and chairs, may be disposed within the outer wall. Thus, a single outer wall may form the sides of the container and the hollow interior portion may be defined by the outer wall. Advantageously, this may allow the container to be formed as part of a single, one-piece blow-molded plastic structure. The container may be cut along all or a portion of its length and/or width to create an opening to allow the table and chairs to be inserted and removed from the hollow interior portion.

Yet another aspect is a case for a table and chair set that may include one or more structures integrally formed as part of the case during the blow-molding process. For example, the case may include a wheel receiving portion that is sized and configured to allow one or more wheels to be attached. Desirably, the wheel receiving portion allows an axle and at least one wheel to be attached to facilitate moving the case. The case may also include a handle receiving portion that is sized and configured to receive at least a portion of a handle. The handle may be moved between an outwardly extending or use position and a storage position. Advantageously, at least a portion of the handle may be disposed in the handle receiving portion when the handle is in the storage position. In addition, the case may include a gripping structure, such as a protrusion, edge and/or recessed portion, to facilitate moving and/or carrying the case. If desired, the gripping structure may be integrally formed with the case as part of a unitary, one-piece construction. Further, the case may include one or more attachment portions that allow the case to be secured in the closed position. If desired, all or a portion of the wheel receiving portion, handle receiving portion, gripping portion and/or attachment portions may be integrally formed with the case as part of a unitary, one-piece structure.

A further aspect is a case for a table and chair set that includes an opening or is open ended. The opening, which may provide access to the entire interior portion of the case, may allow the table and chairs to be quickly and easily inserted and removed from the case. This may allow the case to be integrally formed as part of a unitary, one-piece structure and then an end may be cut off or removed to form the open-ended case. This may also allow two cases to be simultaneously constructed as part of a unitary, one-piece structure and then cut apart to form the two cases. In addition, a strap may be used to secure the table and chairs within the interior portion of the case. Advantageously, the strap may also create a handle that facilitates movement and/or carrying of the case.

A still further aspect is a table and chair set that may be used with a dual purpose case. For example, the case may assist in moving and transporting the table and chairs. In particular, the case may facilitate shipping by the manufacturer and transporting by the retailer and consumer. In addition, the case may facilitate storage of the table and chairs. Significantly, the case may allow the table and chairs to be stored in a single location and/or as part of a group or set. The case may also keep the table and chairs together and/or prevent the table and chairs from being inadvertently separated. The case may also provide a compact, space-saving way to move and store the table and chairs. Further, the case may be lightweight and multiple cases may be stacked, which may facilitate shipping, storing and displaying by the manufacturer, retailer and/or consumer.

These and other aspects, features and advantages of the present invention will become more fully apparent from the following brief description of the drawings, the drawings, the detailed description of preferred embodiments and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limits its scope. Additionally, it will be appreciated that while the drawings may illustrate preferred sizes, scales, relationships and configurations of the invention, the drawings are not intended to limit the scope of the claimed invention. The invention will be described and explained with additional specificity and detail through the use of the accompanying drawings in which:

FIG. 1 is a perspective view of an exemplary embodiment of a table and chair set, illustrating the table and chairs in an unfolded or use position;

FIG. 2 is a perspective view of the table and chair set, illustrating the table and chairs in a folded or collapsed position;

FIG. 3 is a perspective view of the table and chair set, illustrating the table and chairs in an exemplary folded and stacked or aligned configuration;

FIG. 4 is a perspective view of the table and chair set with an exemplary embodiment of a case, illustrating an exemplary configuration and arrangement of the table, chairs and case;

FIG. 5 is a perspective view of the table and chairs disposed within the case; and

FIG. 6 is another perspective view of table and chairs disposed within the case.

### DETAILED DESCRIPTION OF THE PREFERRED EMBODIMENTS

The present invention is directed towards a table and chair set. The principles of the present invention, however, are not limited to a table and chair set. It will be understood that, in light of the present disclosure, the tables and chairs disclosed herein can be successfully used independently and/or in combination with other types of furniture and structures.

Additionally, to assist in the description of the table and chair set, words such as top, bottom, front, rear, right and left are used to describe the accompanying figures. Further, the drawings may be to scale and may indicate preferred shapes, sizes, configurations and/or arrangements of the table and chair set, and various aspects, features, parts and components of the table and chair set. The drawings, however, are not necessarily to scale and the table and chair set may have other suitable shapes, sizes, configurations, arrangements, aspects, features, parts and components. It will be appreciated that the table and chair set can be located in a variety of desired positions, including various angles, sideways and even upside down. A detailed description of the table and chair set now follows.

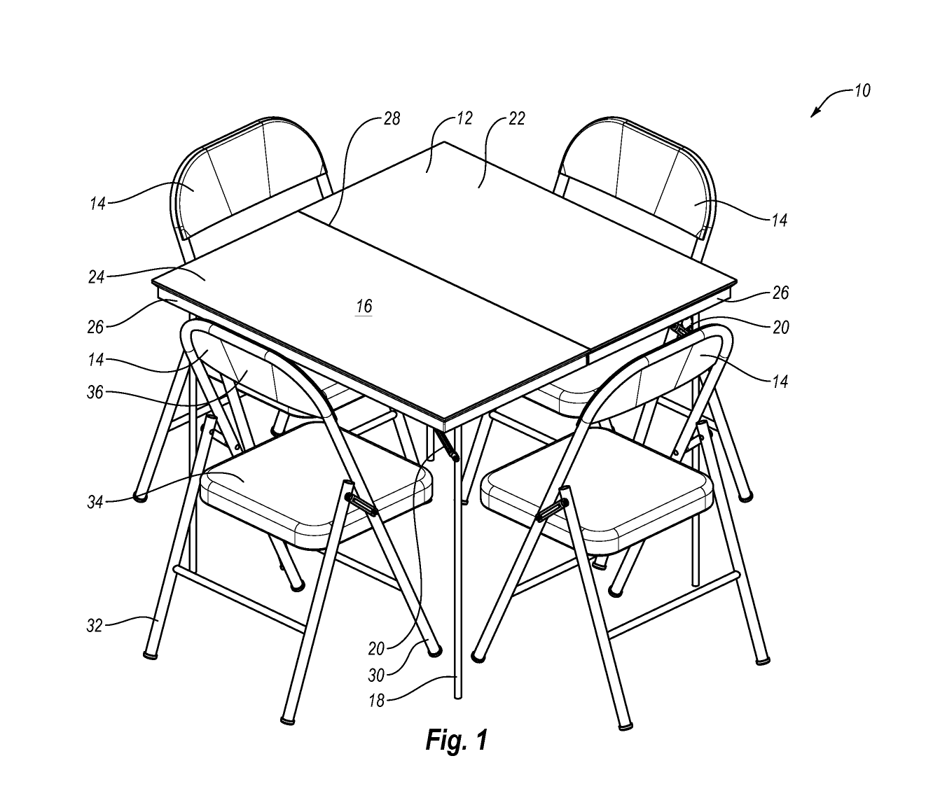

As shown in FIG. 1, the table and chair set 10 may include a table 12 and one or more chairs 14. The table 12 may be a card table with a square table top 16 and legs 18. The legs 18 may be movable between extended and collapsed positions relative to the table top 16. As indicated in the accompanying figures, the legs 18 may be independently attached and individually movable relative to the table top 16. In addition, a brace 20 may assist in attaching the legs 18 relative to the table top 16 and/or help control movement of the legs between the extended and collapsed positions.

The table 12 may be a fold-in-half table in which the table top 16 includes a first section 22 and a second section 24. The first and second sections 22, 24 of the table top 16 are preferably movable relative to each other to create the fold-in-half table. For example, the first and second sections 22, 24 of the table top 16 may be pivotally connected. In addition, the table 12 may include a frame 26 that is connected to the first and second sections 22, 24 of the table top 16. The frame 26 may facilitate connection of the legs 18 to the table top 16 and/or connection of the first and second sections 22, 24 of the table top. The first and second sections 22, 24 of the table top 16 preferably have generally the same size, shape and configuration. In particular, the first and second sections 22, 24 of the table top 16 preferably have the same width and length. Additionally, when the table top 16 is in the folded position, the first and second sections 22, 24 of the table top 16 are preferably disposed adjacent to each other and generally aligned. Thus, the first and second sections 22, 24 of the table top 16 preferably have generally matching shapes and sizes. Further, in the folded position, the first and second sections 22, 24 of the table top 16 are preferably vertically aligned with an outer perimeter of one section aligned with the outer perimeter of the other section.

As shown in FIG. 1, the table and chair set 10 may include one table 12 and four chairs 14. It will be understood that the table and chair set 10 may include any suitable number of tables and chairs. It will also be understood that the table 12 and chair 14 may have various suitable shapes, sizes, configurations and arrangements. For example, the table 12 preferably has a square table top 16 with sides measuring between about two and about four feet in length, although such lengths may be larger or smaller in other embodiments. For example, the table top 16 may have a length and a width of about three feet or thirty-six inches in the unfolded position, and the first and section sections 22, 24 of the table top may have a length of about thirty-six inches and a width of about eighteen inches in the folded position. The table top 16 may also have other shapes and sizes, such as a rectangular or circular configuration, with sides or diameters measuring between about two feet and about twelve feet in length. The table 12 may have one or more various features, aspects, components, shapes, sizes and configurations, such as shown in U.S. Pat. Nos. 6,945,178; 6,431,092; 7,707,947; 7,299,754; 7,096,799; 7,299,753; 7,461,601; 7,703,402; 7,975,625; and 8,042,476; which are incorporated by reference in their entireties.

The table 12 and chairs 14 shown in FIG. 1 are in the unfolded or use positions. In this configuration, the table 12 can be used to support one or more items such as games, food, or other objects. The first and second sections 22, 24 of the table top 16 may be separated by a fold line 28. In this embodiment, the fold line 28 extends in a single direction and is approximately centered between the opposing sections 22, 24 of the table top 16. Thus, the fold line 28 may separate the table top 16 into two sections that are of approximately equal size. For instance, if the table top 16 has sides of about three feet in length, the fold line 28 may separate the table top into first and second sections 22, 24 measuring about three feet in length by about one and a half feet in width.

In greater detail, the fold line 28 represents a line along which the table top 16 can be folded. For instance, the first section 22 of the table top 16 can be rotated relative to the second section 24 of the table top. In particular, the first section 22 may be rotated about one hundred eighty degrees such that the undersides of the first and second sections 22, 24 are disposed at least adjacent and/or contact or engage each other. If desired, the first and second sections 22, 24 may be connected by one or more hinges. Although the first and second sections 22, 24 may be rotated relative to each other in the manner described, the table top 16 may be disposed in the collapsed position in any suitable manner. For example, the first and second sections 22, 24 of the table top 16 may be moved such that the upper surfaces of the table top are disposed at least adjacent and/or contact or engage each other in the closed position.

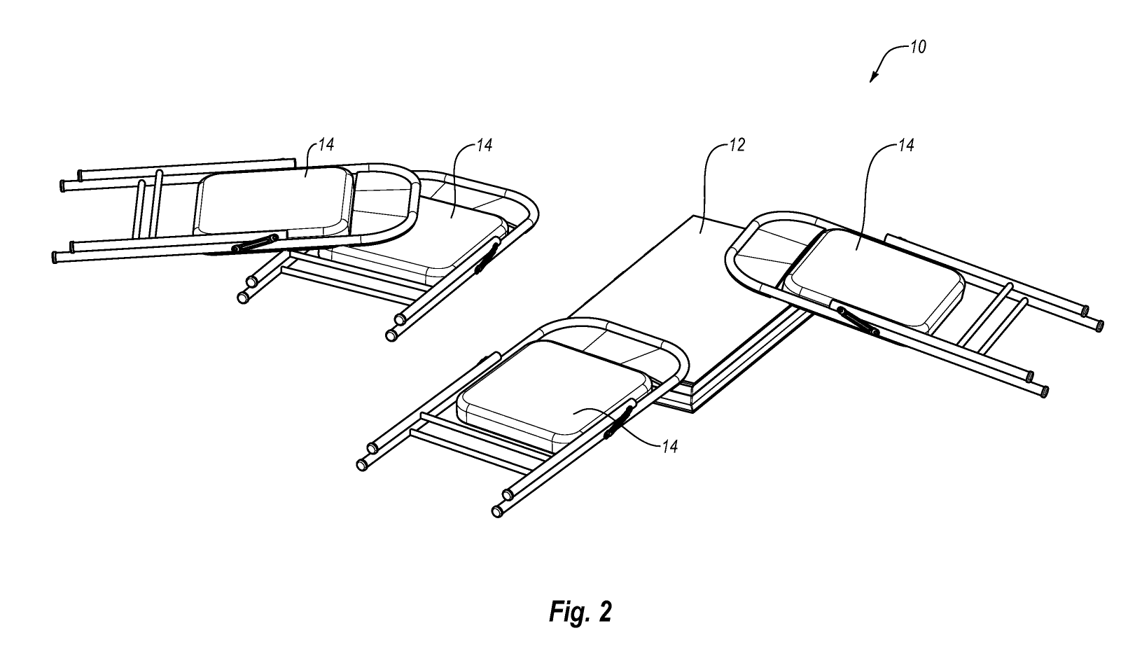

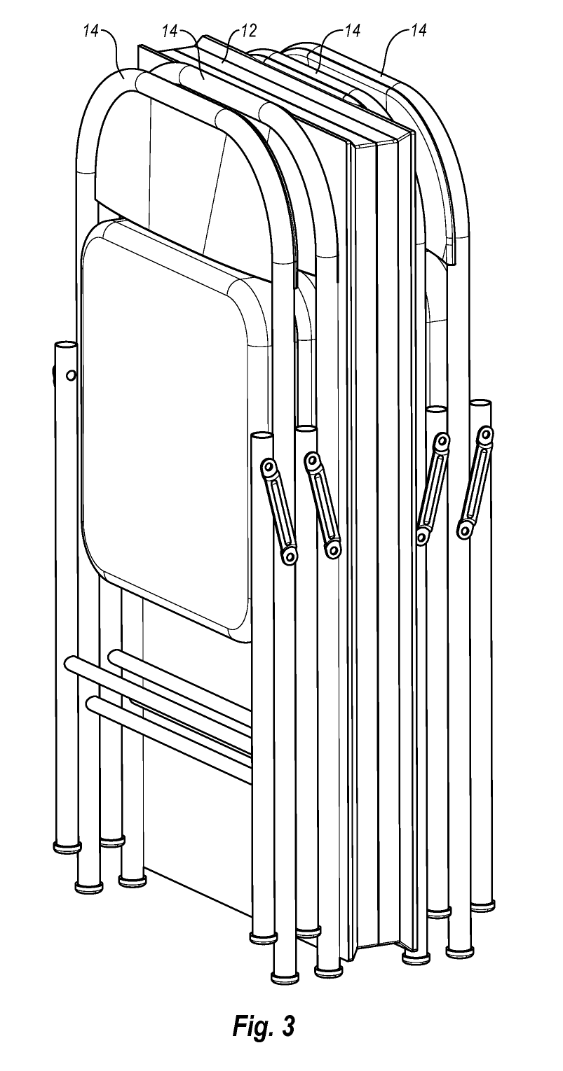

As shown in FIG. 1, the folding chairs 14 are disposed in a seating position. The chairs 14 may include front legs 30 and rear legs 32, a seat 34, and a backrest 36. The front and rear legs 30, 32 may be movable relative to each other to place the chair 14 into a folded or collapsed configuration such as illustrated in FIGS. 2 and 3. The chairs 14 may have one or more various features, aspects, components, shapes, sizes and configurations, such as shown in U.S. Pat. Nos. 6,543,842; 7,017,986; and 7,452,035; which are incorporated by reference in their entireties.

FIG. 2 illustrates an exemplary embodiment of the table and chair set 10 including the table 12 and four chairs 14. As shown in FIG. 2, the table 12 and chairs 14 are in the folded, collapsed or storage configuration. Advantageously, the folded or collapsed configuration may facilitate storage of the table 12 and chairs 14. In addition, the folded or collapsed configuration may assist and enable stacking or otherwise arranging the table 12 and/or chairs 14 for storage.

For example, as shown in FIG. 3, the folded table 12 and chairs 14 may be disposed in a stacked or aligned configuration. In this exemplary embodiment, two chairs 14 are placed in the folded configuration, arranged in a similar orientation, and positioned adjacent to each other. The table 12 may then be placed adjacent to the two aligned chairs 14. The two more chairs 14 may then be aligned in a manner similar to the other chairs and placed adjacent to the table 12. While the table 12 and the chairs 14 are vertically aligned, the outer perimeters or edges of the table and chairs may also be aligned. It will be appreciated the table 12 and chairs 14 may be disposed in other arrangements and configurations such as horizontal, angled and the like.

The stacking or alignment of the table 12 and chairs 14 shown in FIG. 3 is merely illustrative. For instance, in another embodiment, the table 12 may be positioned on one side and the chairs 14 may be placed on the other side. It will be appreciated that the table 12 may be placed on either side of the chairs, and any number of chairs may be placed on either side of the table. Further, other arrangements and orientations of the table and/or chairs may also be possible. For example, the table and chair set 10 may include more or fewer chairs 14 and/or tables 12, in which case the arrangement may be altered. In addition, the tables 12 and/or chairs 14 may have different shapes, sizes, configurations and arrangements, which may allow the table and chairs to be stacked in different configurations and arrangements. As an example, the table 12 may be a banquet table with a rectangular table top, which may be folded into one or more sections, and one or more chairs may be stacked or aligned on one or both sides of the table. Further, the table 12 and chairs 14 may be stacked or aligned in different arrangements or configurations. For example, one or more chairs 14 may be disposed in a first direction and other chairs may be disposed in a second direction.

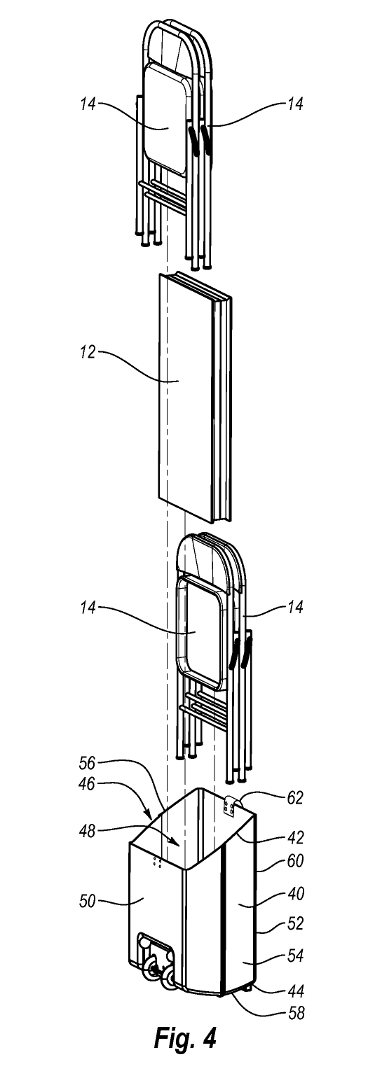

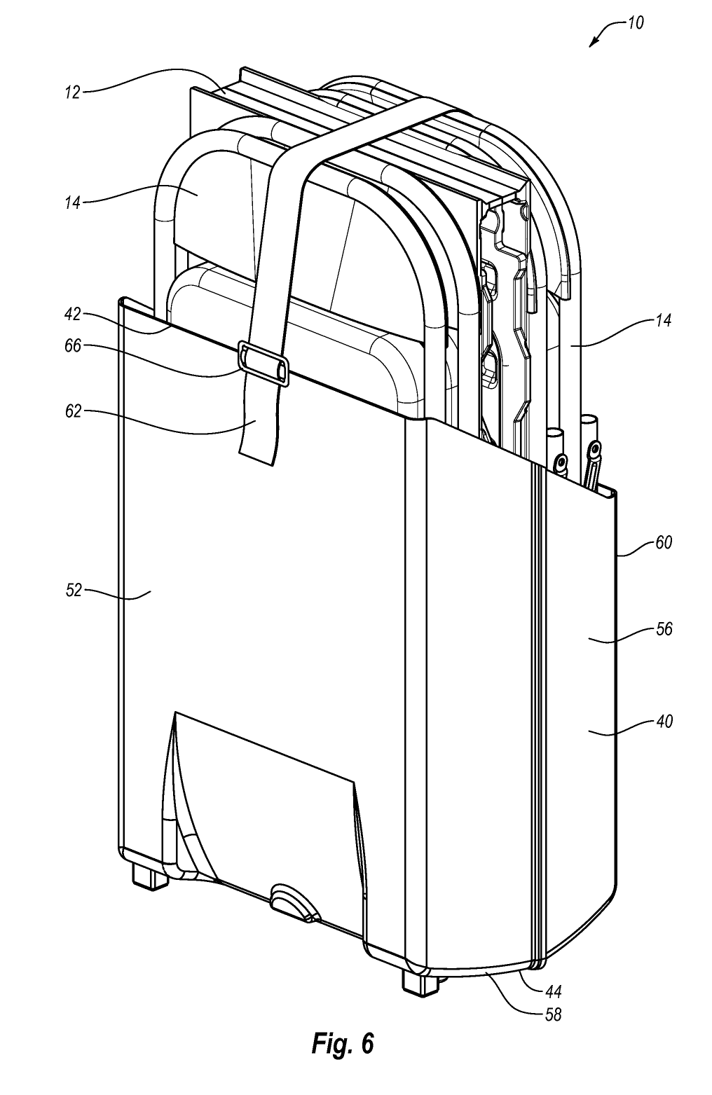

As shown in FIGS. 4-6, a container or case 40 may be used in connection with the table 12 and chairs 14. Thus, the table and chair set 10 may include a table 12, four chairs 14 and a case 40 to form a six piece set. The case 40 may allow at least a portion of the table 12 and/or chairs 14 to be selectively enclosed or otherwise disposed within the case. As shown in FIG. 4, the case 40 may include an upper portion 42 and a lower portion 44. The upper portion 42 is preferably open ended and includes an opening 46 to an interior portion 48 of the case 40. The opening 46 and interior portion 48 are preferably sized and configured to receive the table 12 and chairs 14.

By way of illustration, as best seen in FIG. 4, the case 40 may include a front surface 50, a rear surface 52, a first side 54, a second side 56 and a lower surface 58. The interior 48 of the case may be defined by the front surface 50, rear surface 52, first side 54, second side 56 and lower surface 58. As seen in FIGS. 4-6, at least a portion of the folded, aligned table 12 and chairs 14 may be disposed in the interior 48 of the case 40.

In greater detail, the case 40 may include an outer wall 60 that forms at least a portion of the front surface 50, rear surface 52, first side 54, second side 56 and lower surface 58. The depth of the interior 48 of the case 40 may be measured between the front and rear surfaces 50, 52, and the width of the case may be measured between the sides 54, 56. The interior 48 of the case 40 may be large enough to receive the table 12 and chairs 14. It will be appreciated that the case 40 may have other suitable shapes, sizes, configurations and arrangements depending, for example, upon the shape and size of the table 12 and/or chairs 14. For example, the case 40 may have one or more shapes, sizes, features, aspects and the like as shown in Assignee's pending U.S. patent application Ser. No. ______, filed Jan. 9, 2012 (attorney docket no. L1006.10116US02), which is incorporated by reference in its entirety.

A strap 62 may be used to secure the table 12 and/or chairs 14 within the interior 48 of the case 40. For example, one or both ends of the strap 62 may be connected to the case 40 by one or more fasteners 64. The strap 62 may be constructed from a relatively flexible material, such as fabric, webbing or the like, but the strap may be constructed from any suitable materials or structures. The strap 62 may also be connected to the case 40 by one or more fastening devices 66, such as a buckle. It will be appreciated that the strap 62 may be connected to any suitable portions of the case 40. In addition, all or a portion of the strap 62 may be selectively removable and/or securely attached to the case 40. Significantly, the strap 62 may be used to securely and selectively retain the table 12 and chairs 14 within the case 40. In addition, the strap 62 may advantageously be used as a handle.

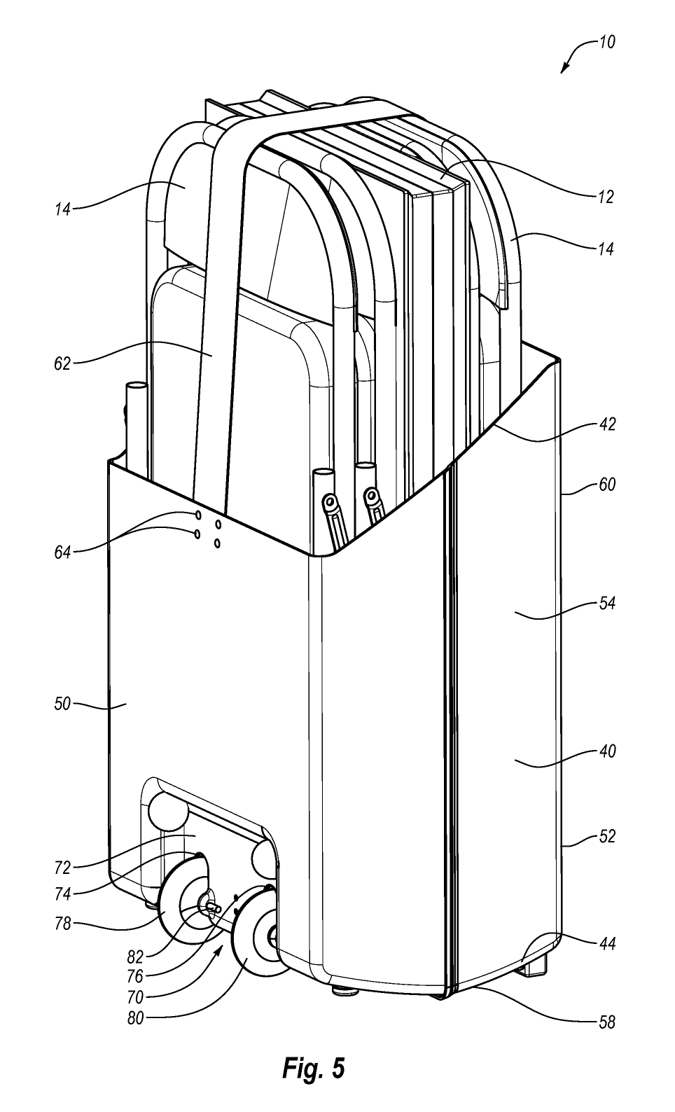

The case 40 can allow efficient, easy and convenient transport and storage of the table 12 and chairs 14. The case 40 may also include one or more mechanisms or structures to facilitate transportation and/or storage. For instance, as seen in FIGS. 4 and 5, the case 40 can include a wheel assembly 70. The wheel assembly 70 may be at least partially disposed within a wheel assembly receiving portion 72 formed in the front surface 50 of the case 40. The wheel assembly receiving portion 72 is preferably located towards an end of the case 40 and may include a first wheel receiving portion 74 and a second wheel receiving portion 76 that are sized and configured to receive a portion of a first wheel 78 and a second wheel 80. The wheels 78, 80 may be connected to one or more axles 82 and the ends of the axle may be disposed within openings, apertures or receiving portions to allow the wheels to rotate relative to the case 40.

In greater detail, the wheel assembly receiving portion 72 may be formed in the front and lower surfaces 50, 58 of the case 40. In addition, if the wheel assembly receiving portion 72 extends inwardly into the interior 48 of the case 40, it is preferably sized and configured to allow the legs 18 of the chairs 14 to be disposed around the wheel assembly receiving portion. That is, on one side, the legs 18 of the chairs 14 may be disposed between the side wall 54 and the wheel assembly receiving portion 72 and, on the other side, the legs may be disposed between the side wall 56 and the wheel assembly receiving portion. Thus, a first chair leg receiving portion may be disposed between side wall 54 and the wheel assembly receiving portion 72 and a second chair leg receiving recess may be disposed between the side wall 56 and the wheel assembly receiving portion. Advantageously, this may help align and/or position the chairs 14 and/or table 12 within the case 40. In addition, this may help prevent the chairs 14 and/or table 12 from inadvertently sliding or moving within the case 40.

The wheel assembly 70 may also have other suitable shapes, sizes, arrangements and configurations depending, for example, upon the intended use of the table and chair set 10. For example, the wheels 78, 80 and/or axle 82 may be mounted on one or more bearings, bushings, journaled connections, and the like, or operate in another manner that allows the wheels to rotate so as to facilitate transport of the table and chair set 10. Optionally, the wheels 78, 80 may extend into the interior 48 of the case 40. In some embodiments, the extent to which the wheels 78, 80 extend into interior 48 may be less than or equal to the depth of two chairs 14 in the folded and aligned configuration. In such a configuration, two chairs 14 may be aligned such that the legs 18 are positioned adjacent the wheels 78, 80. The legs 18 may be sized, configured and spaced apart such that the chairs 14 do not interfere with the rotation of the wheels 78, 80. Positioning the wheels 78, 80 in such a manner can also reduce the overall size of the case 40 and/or allow the size of wheels to be increased, which may provide better stability and/or ease of movement of the table and chair set 10.

The wheels 78, 80 are preferably positioned to allow the case 40 to stand in an upright configuration as shown in FIGS. 4-6. In addition, the wheels 78, 80 are preferably positioned to allow the case 40 to be disposed in a horizontal configuration. Thus, the wheels 78, 80 may not extend beyond a plane aligned with the front surface 50 and/or the lower surface 58 of the case 40. In this embodiment, multiple cases 40 may be stacked and aligned, which may facilitate shipping by the manufacturer, displaying and storing by the retailer, and use by the consumer.

The wheel assembly 70 may allow the case 40 to be wheeled from one location to another. Thus, during a single trip, a person can transport the table and chair set 10 which may include one or more tables 12 and chairs 14. Accordingly, a six piece set (one table 12, four chairs 14 and the case 40) can be efficiently moved and transported by an individual. Furthermore, the case 40 can have a size that is relatively easy to store. For example, as noted above, the table 10 may have a size of about three feet by about eighteen inches in the folded position. The chairs 14 may also have a size of about three feet by about eighteen inches in the folded position. Therefore, when the folded table 12 and chairs 14 are stacked or aligned, the outer perimeter of the table and chairs may also be generally aligned. In addition, the table 12 and chairs 14 may fit tightly and securely within the interior 48 of the case 40. Thus, the interior 48 of the case 40 may have dimensions slightly larger than the outer perimeter of the folded table 12 and chairs 14. For example, if the folded table 12 and chairs 14 have an outer perimeter of about three feet by about eighteen inches, then the interior 48 of the case 40 may have dimensions slightly larger than about three feet by about eighteen inches. Further, the case 40 may have outer dimensions only slightly larger than about three feet by about eighteen inches. For example, if the case 40 is constructed from blow-molded plastic and includes only a single wall between the interior and exterior surfaces of the container, the case will have dimensions only slightly larger than the outer periphery of the folded table 12 and chairs 14.

The case 40 may have a height that is between one-quarter and three-quarters of the height of the folded, aligned table 12 and chairs 14. In addition, the height of the case 40 may vary between the front and rear surfaces 50, 52. Thus, the opening 46 to the interior 48 of the case 40 may be angled. In greater detail, one portion of the case 40 may have a height between about forty and sixty percent of the height of the folded, aligned table 12 and chairs 14, such as about fifty percent of the height of the folded, aligned table and chairs. Another portion of the case 40 may have a height between about fifty and seventy-five percent of the height of the folded, aligned table 12 and chairs 14, such as about sixty-five percent of the height of the folded, aligned table and chairs. It will be appreciated that the height of the case 40 may vary depending, for example, upon the intended use of the table and chair set 10. It will also be appreciated that the height of the case 40 may be constant or vary depending, for example, upon the intended use of the case.

For example, as shown in the attached figures, the case 40 has an open end in which the legs 18 or backrests 36 of the chairs 14 are either inserted or removed from the case. The case 40 may allow all or at least a substantial portion of the chairs 14, such as the backrests 36, to extend out of the opening 46 in the case. This may assist a user in inserting and removing the tables 12 and chairs 14 from the case. It will be understood that any desired portions of the tables 12 and chair 14 may extend out of the case. Further, the case 40 may have other embodiments such as a case that may be open along a full side and an interior cavity with a footprint that is sized generally corresponding to a full width and height of the folded table 12 and/or chairs 14. In such a case, no portion of the table 12 and/or chairs 14 may extend out of the case 40. Rather, a vertical stack of the tables 12 and chairs 14 may be placed within the case 40 and, if desired, at least a top surface of the top chair or table may be exposed. A mesh, net, one or more straps, or other mechanism may then be used to secure the tables 12 and chairs 104 within the case 40.

The case 40 may have a depth or length that allows the table 12 and chairs 14 to be tightly or snuggly disposed within the interior 48 of the case. For example, the table 12 in the folded configuration may have a thickness between about three and four inches and the chairs 14 in the folded configuration may have thickness between about three and five inches, such as about four inches. Therefore, if the table and chair set 10 includes one table 12 and four chairs 14, then the stacked components may have combined depth or thickness be between about fifteen and twenty-four inches. The case 40 preferably has a depth or length that corresponds to the depth or thickness of the stacked table 12 and chairs 14 in order to minimize the size of the case.

The case 40 may be integrally formed as part of a unitary, one-piece structure. In particular, if the case 40 is constructed from blow-molded plastic, then the case and wheel assembly receiving portion 72 may be integrally formed as port of the unitary, one-piece structure during the blow-molding process. Advantageously, this may simplify and expedite the manufacturing process.

If the case 40 is constructed from blow-molded plastic, a single outer wall may form the front surface 50, rear surface 52, side walls 54, 56 and lower surface 58. In particular, the entire case 40 may be blow-molded at one time and the outer wall of the blow-molded plastic structure may form front surface 50, rear surface 52, side walls 54, 56 and lower surface 58 of the case. Significantly, this may allow the entire case 40 to be formed at once and the outer wall may only have a single layer, which may decrease the weight and amount of material required to make the case. Further, if the case 40 is formed with a single outer wall, the dimensions of the case may be decreased and that may facilitate shipping and storage of the case.

The case 40 may be cut along its length and/or width to create the opening 46. For example, as shown in the attached figures, the case 40 may be cut at an angle along the front surface 50, rear surface 52, and side walls 54, 56. If the case 40 is constructed from blow-molded plastic and includes an outer wall with a single thickness, it may be relatively easy to cut.

During the manufacturing process, the case 40 may be constructed from blow-molded plastic and various features may be integrally formed as part of a unitary, one-piece structure. The case 40 may then be cut to create the opening 46 into which the tables 12 and chairs 14 may be loaded and unloaded. The table 12 and chairs 14 may be secured within the case 40 by the strap 62. The manufacturer may then ship and/or transport the case 40 to retailers or consumers.

The table and chair set 10 may be used by aligning one or more tables 12 and chair 14, as shown in FIG. 4, and then inserted the tables and chairs into the opening 46 into the interior 48 of the case 40. In greater detail, two folded chairs 14 may be placed in the interior 48 of the case 40 with the legs 18 disposed in the chair leg receiving portions located between the side walls 54, 56 of the case 40 and the wheel assembly receiving portion 72. A folded table 12 may then be disposed adjacent to the folded chairs 14 and two more folded chairs may be disposed adjacent to the table. The folded table 12 and chairs 14 preferably have the same general footprint such that the perimeter of the table and chairs is generally aligned. In addition, the table 12 and chairs 14 are preferably sandwiched together. The strap 62 may be used to secure the table 12 and chairs 40 within the case 40. The wheels 88, 90 and/or strap 62 may be used to move the case 40 into a desired location.

When it is desired to use the table and chair set 10, the case 40 may be opened by removing and/or unfastening the strap 62. The table 12 and chair 14 may then be taken out of the case 40. The table 12 and chairs 14 may be stored or returned to the case 40 by inserting the table and chairs through the opening 46 and into the interior 48 of the case. Advantageously, the table and chair set 10 may be easy to use, lightweight and readily portable.

It will be appreciated that the table and chair set 10, and its various components such as the table 12, chairs 14 and case 40, may have a variety of suitable shapes, sizes, configurations and arrangements depending, for example, upon the intended use of the table and/or chairs. It will also be appreciated that the devices, apparatus, kits, components and the like disclosed herein may be formed or made in any suitable manner, and can be made of any number of different materials. For instance, the tables, chairs and/or containers of the table and chair set 10 may be formed from one or more materials such as metals, composites, polymers, organic materials and the like. In greater detail, in accordance with an exemplary embodiment, the table 12 may include components constructed from metal, such as the frame and/or legs, and other components constructed from other materials, such as a plastic or polymeric table top. In addition, various components of the table and chair set 10 may be constructed from different processes such as the table top 16 may be formed from blow-molded plastic because, for example, it allows a strong, lightweight, rigid and sturdy table top to be quickly and easily manufactured. Other conventional molding processes, such as rotational molding and injection molding, can also be used. Advantageously, a blow-molded plastic table top may be lighter weight that conventional table tops constructed from wood or metal, although the table top may be formed of metals or wood. The chairs 14 may be similarly constructed. For instance, the seat 34 and/or the backrest 36 may be formed from blow-mold plastic because, for example, it allows a strong, lightweight, rigid and sturdy part to be quickly and efficiently manufactured. Metal and/or wood chairs may, also be used. Chairs 14 may also include, in some embodiments, fabric or other elements.

The case 40 may be constructed such that it is substantially rigid but, in other embodiments, all or a portion of the container may be flexible. For instance, the case 40 may be constructed from blow-molded plastic because blow-molded plastic is relatively durable, weather resistant, temperature insensitive, corrosion resistant, rust resistant, and blow-molded plastic generally does not deteriorate over time. One skilled in the art will appreciate that the case 40 does not have to be constructed from blow-molded plastic and other suitable materials and/or processes can be used, such as other types of plastics, polymers, synthetic materials, natural materials, or any other material or combination thereof. In addition, the case 40 may be constructed from other materials with sufficient strength and desirable characteristics such as plywood, particle board, solid wood, wood slates, metal alloys, fiberglass, ceramics, graphite, and the like. Portions of a table 12 and/or chairs 14 may similarly be constructed.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A table and chair set comprising:
a folding table including a first table top section and a second table top section movable between a folded position and an unfolded position, the folding table top having a footprint in the folded position;
a folding chair movable between a folded position and an unfolded position, the folding chair having a footprint in the folded position generally equal or slightly smaller than the footprint of the folding table in the folded position; and
an open-ended case including a cavity sized and configured to receive at least a portion of the folding table and the folding chair in the folded positions, the cavity having a width and a depth generally equal to or slightly larger than a width and a depth of the folding table and the folding chair in an aligned and folded configuration to allow an outer perimeter of the folding table and an outer perimeter of the folding chair to be disposed at least proximate an interior of the cavity.

2. The table and chair set as in claim 1, wherein the case is constructed from blow-molded plastic;
wherein a single wall of the blow-molded plastic structure forms an outer wall of the case and an inner wall of the cavity.

3. The table and chair set as in claim 1, further comprising four folding chairs, each of the folding chairs having a height and a width in the folded position that is generally equal to a height and a width of the table top in the folded position.

4. The table and chair set as in claim 3, wherein the cavity is sized and configured to receive a portion of the folding table and the four folding chairs in the folded positions; and
wherein a portion of the folding table and the four folding chairs in the folded positions are disposed outside of the cavity.

5. The table and chair set as in claim 3, wherein the footprint of the folding table and the folding chair in the folded positions is generally equal to or slightly less than about thirty-six inches by about eighteen inches.

6. The table and chair set as in claim 1, further comprising:
a wheel assembly receiving portion integrally formed in the second portion of the case as part of a unitary, one-piece structure;
a first chair leg receiving portion disposed between a first side wall of the second portion of the case and the wheel assembly receiving portion; and
a second chair leg receiving portion disposed between a second side wall of the second portion of the case and the wheel assembly receiving portion.

7. The table and chair set as in claim 1, further comprising:
a first wheel receiving portion integrally formed in the second portion of the case as part of a unitary, one-piece structure;
a second wheel receiving portion integrally formed in the second portion of the case as part of the unitary, one-piece structure;
a first wheel disposed in the first wheel receiving portion; and
a second wheel disposed in the second wheel receiving portion;
wherein when the folding chair is disposed in the second portion of the case, a first chair leg is disposed between a first side wall of the second portion of the case and the first wheel and a second chair leg is disposed between a second side wall of the second portion of the case and the second wheel.

8. The table and chair set as in claim 1, further comprising a strap attached to the case, the strap sized and configured to retain the folding table and the folding chair in the cavity.

9. The table and chair set as in claim 1, further comprising four folding chairs, each of the folding chairs having a height and a width in the folded position that is generally equal to a height and a width of the table top in the folded position;
wherein the four folding chairs and the folding table are disposed in an aligned configuration within the cavity when the folding chairs and the folding table are disposed inside the cavity.

10. The table and chair set as in claim 9, wherein a first chair contacts an inner surface of the cavity of the first portion of the case;
wherein a second chair, the table and a third chair are stacked and aligned with the first chair;
wherein a fourth chair contacts an inner surface of the cavity of the second portion of the case;
wherein the four chairs and table are disposed in stacked configuration with the footprint of the chairs generally aligned with the footprint of the table; and
wherein the inner surface of the cavity of the first portion of the case, the four folding chairs, the folding table and the inner surface of the cavity of the second portion of the case are sandwiched together when the chairs and the table are disposed within the case.

11. A table and chair set comprising:
at least one folding table including a table top movable between a folded position and an unfolded position;
at least four folding chairs, each chair movable between a folded position and an unfolded position; and
a storage case constructed from blow-molded plastic, the storage case comprising:
a single wall forming an outer perimeter of the storage case, an outer surface of the single wall forming an outer surface of the case;
an interior cavity sized and configured to receive at least a portion of the at least one folding table in the folded position and the at least four folding chairs in the folded position, an inner surface of the single wall forming the interior cavity; and
an opening sized and configured to allow the at least one folding table and the at least four folding chairs to be inserted and removed from the storage case;
wherein the single wall, the interior cavity and the opening of the case are integrally formed during the blow-molding process as part of a unitary, one-piece construction.

12. The table and chair set as in claim 11, wherein the folding table has a footprint in the folded position;
wherein the folding chair has a footprint in the folded position substantially equal to the footprint of the folding table in the folded position; and
wherein the interior cavity of the storage case has an inner perimeter corresponding to a portion of the footprint of the folding table and the footprint of the folding chair to allow an outer perimeter of the folding table and an outer perimeter of the folding chair to be disposed at least proximate a portion of the inner perimeter of the storage case.

13. The table and chair set as in claim 11, further comprising:
a first wheel receiving portion integrally formed in the storage case as part of a unitary, one-piece structure;
a second wheel receiving portion integrally formed in the storage case as part of the unitary, one-piece structure;
a first wheel disposed in the first wheel receiving portion; and
a second wheel disposed in the second wheel receiving portion;
wherein when a folding chair is disposed in the storage case, a first chair leg is disposed between a first side wall of the storage case and the first wheel and a second chair leg is disposed between a second side wall of the storage case and the second wheel.

14. The table and chair set as in claim 11, wherein each of the folding chairs has a height and a width in the folded position that is generally equal to a height and a width of the table top in the folded position;
wherein the folding chairs and the table are aligned in a stacked configuration within the interior cavity of the storage case.

15. The table and chair set as in claim 11, further comprising:
a wheel assembly receiving portion integrally formed in the single outer wall of the storage case, the wheel assembly receiving portion allowing at least one wheel to be attached the storage case; and
a strap attached to the case, the strap sized and configured to retain the folding table and the folding chair in the cavity.

16. A method of manufacturing a case for a table and chair set, the method comprising:
blow-molding a storage case from a single blow-molded plastic wall, an outer portion of the single wall forming an outer perimeter of the storage case and an inner portion of the single wall forming an interior cavity, the interior cavity being sized and configured to receive at least a portion of a table with a folding table top in a folded position and four chairs in a folded position; and
cutting an opening in the storage case to allow the table and the chairs to be inserted and removed from the storage case.

17. The method as recited in claim 16, wherein the table top in the folded position has a footprint that is substantially equal to a footprint of the chairs in the folded position; and
wherein the interior cavity of the storage case has inner dimensions at least partially equal to the footprint of the table top in the folded position and the footprint of the chairs in the folded position.

18. The method as recited in claim 16, wherein the storage case is sized and configured to allow two of the four chairs to be placed within the storage case prior to placing the table within the storage case.

19. The method as recited in claim 16, further comprising:
integrally forming a first wheel receiving portion in the storage case as part of the unitary, one-piece structure;
integrally forming a second wheel receiving portion in the storage case as part of the unitary, one-piece structure;
disposing a first wheel in the first wheel receiving portion; and
disposing a second wheel in the second wheel receiving portion;
wherein when a chair is disposed in the storage case, a first chair leg is disposed between a first side wall of the storage case and the first wheel and a second chair leg is disposed between a second side wall of the storage case and the second wheel.

20. The method as recited in claim 16, further comprising integrally forming a wheel assembly receiving portion in the single wall of the storage case, the wheel assembly receiving portion allowing at least one wheel to be attached the storage case.
